(19) United States
(12) Patent Application Publication
(10) Pub. No.: US 2004/0163675 A1
(43) Pub. Date: Aug. 26, 2004

(54) Device

(76) Inventors: Karlheinz Hanh, Otterstadt (DE); Jurgen Schick, Hemsbach (DE); Tobias Schultheis, West Ryde (AU)

Correspondence Address: Norris McLaughlin & Marcus, 30th Floor, 220 East 42nd Street, New York, NY, 10017, US

(21) Appl. No.: 10/472,792

(22) PCT Filed: Mar. 27, 2002
(86) PCT No.: PCT/GB02/01184

(30) Foreign Application Priority Data
Mar. 27, 2001 (GB) 0107593.6

(51) Int. Cl. B08B 3/02

(52) U.S. Cl. 134/7; 134/93; 134/201; 137/268; 134/25.2

(57) ABSTRACT

A device for use in a dishwashing machine to dispense a water-soluble glass or ceramic composition into the machine over a plurality of dishwashing cycles comprising: a) a shaped body made of the water-soluble glass or ceramic composition; and b) a container for holding said shaped body with at least part of its walls having perforations allowing a controlled circulation of the washing liquor into and out of the container.

The invention is related to a device for use in a dishwashing machine to dispense a water-soluble glass or ceramic composition into the machine over a plurality of dishwashing cycles as well as to a process for protection of glassware in a dishwashing machine against corrosion.

Corrosion of glassware in cleaning and/or rinsing cycles of an automatic dishwashing machine is a well-known problem. This corrosion problem will create, after a certain number of cleaning cycles, damages on the glassware, such as turbidity, scratches, streaks and the like.

There are different approaches in the prior art proposed for the solution of above identified problems.

One approach is the use of zinc, either in metallic form (U.S. Pat. No. 3,677,820) or in the form of zinc compounds.. The use of soluble zinc salts for inhibition of corrosion of glassware in automatic dishwashing processes is, for example, disclosed in U.S. Pat. No. 3,255,117.

Another approach is the use of insoluble zinc compounds for the inhibition of corrosion of glassware in automatic dishwashing processes as described in European Patent Application EP 0 383 480 A1, EP 0 383 482 A1 and EP 0 387 997 A1. More particularly insoluble zinc salts such as zinc silicate, zinc carbonate, zinc oxide, basic zinc carbonate, zinc hydroxide, zinc oxalate, zinc monophosphate and zinc pyrophosphate have been proposed.

With these prior art compositions, it is disadvantageous that, due to the low solubility, or even insolubility, of the zinc compounds, it is difficult, if not impossible, to ensure an continuously sufficient amount of active corrosion inhibiting agent in the wash liquor or rinse water.

WO 00/39259 and DE 10010209 disclose the use of water-soluble glass and vitro-ceramic compositions, respectively, as corrosion protection for glassware. These compositions comprise at least one compound, which in cleaning and/or rinsing cycles of a dishwashing machine releases a corrosion inhibiting agent.

It has been suggested that it may be advantageous to use such water-soluble glass or ceramic materials in the form of a large shaped body, which could be placed into the dishwasher and would allow a prolonged glass protection effect. This solution offers a number of advantages compared to the incorporation of the glass or ceramic compositions in powder or granular form into conventional detergent or rinse compositions.

A first advantage can be found in that the shaped bodies provide a more effective glassware protection that the powders as they guarantee a maintained presence of the protecting agent in the washing liquor over the complete washing process (i.e. pre-washing, washing, rinsing and drying cycles).

A second advantage is consumer convenience as a shaped body can be designed to last over a plurality of cleaning cycles saving the consumer the need to dose the glass protecting composition at every single cleaning cycle.

The consumer only needs to replace the shaped body once it is fully exhausted.

This second advantage in term of convenience for the consumer has proven to be highly appreciated by users which makes the use of shaped bodies lasting for more than one cycle one of the preferred ways of using the glass-protecting glass or ceramic compositions of the invention.

However, when actually testing the water-soluble shaped bodies described in WO00/39259 a number of problems have become apparent.

A first problem is that the shaped bodies show the undesirable tendency of developing sharp edges on dissolution. This is indeed a big problem for their use by the consumers particularly when large shaped bodies for several cycles are intended as there is the potential risk that the consumer is injured when manipulating the contents of the dishwasher (plates, cutlery, . . . ) in the vicinity of the region where the partially dissolved shaped bodies having developed sharp edges are to be found.

The applicant has tried to find a solution to the problem of the shaped bodies developing sharp edges by giving the shaped bodies different shapes in the hope to find a shape, which will avoid the development of the “sharp edges”. This route has however proven to be not sufficient to fully solve the problem.

A second problem is that, when the shaped body is added to the dishwasher without taking special measures to control its free movement within the machine, it may end up sitting in the bottom of the machine reservoir close to the heating elements of the dishwasher. This will have the undesirable effect of substantially increasing the dissolution rate of the shaped body thereby unnecessarily shortening its lifetime. Alternatively the glass may get stacked in a place within the dishwasher where it is poorly exposed to the washing liquor. This will result in a sub-optimal glass-protecting performance.

Although the above-mentioned disadvantages would be solved by instructing the consumer to place the shaped body in an existing predetermined position of the dishwasher where its capacity to move is restricted, this may also cause problems.

The straightforward point to place the shaped body if one wants to restrict its movement is the cutlery basket.

However, placing the shaped body in the cutlery basket has also a number of disadvantages for the consumer. One clear disadvantage is that it occupies space the consumer would have used to place its cutlery thereby reducing the efficiency of the cleaning process as fewer cutleries per wash can be placed in the dishwasher. Another disadvantage is that once the shaped body is sitting in the cutlery basket, the consumer may drop cutlery in the compartment occupied by the shaped body causing it to break with the risk that the consumer is then injured by the broken glass or that small pieces of glass or ceramic may damage the dishwasher.

Still a third problem of using the glass shaped bodies in the dishwasher arises from the thermal shock they have to face when hot washing liquor is pumped off the machine and new fresh cold water enters the machine in a short time period. This thermal shock may again cause the shaped body to break with the associated problems described above.

Thus, it is an object of the present invention to provide a system whereby shaped bodies of water-soluble glass or vitroceramic compositions can safely be used by consumers in a dishwashing machine without the risk of damaging the machine or injuring consumers.

It is a further object of the present invention to provide a system whereby shaped bodies of water-soluble glass or vitroceramic compositions are prevented from moving freely within the interior of a dishwashing machine.

It is still a further object of the invention to provide a system whereby the thermal shock experienced by the glass shaped bodies is reduced.

These objects are solved, within the present invention, by providing a device for use in a dishwashing machine to dispense a water-soluble glass or ceramic composition into the machine over a plurality of dishwashing cycles comprising: a) a shaped body made of the water-soluble glass or ceramic composition; within b) a container for holding said shaped body with at least part of its walls having perforations allowing a controlled circulation of the washing liquor into and out of the container.

Furthermore, it is preferred that the means be provided on the container or connected therewith to fix the container to a pre-determined position within the dishwashing machine.

Preferably, the device provides means for fixing adapted to fix the container to a predetermined position on the racks of the dishwashing machine.

Furthermore, in a preferred embodiment, the invention relates to a device, wherein at least a part of the container is made of transparent material.

Preferably, the container is provided for in a form, which does not allow access to the contents thereof without irreversible destruction of the container.

In a preferred embodiment the container comprises means for detection of that point in time beyond which full functionality of the water-soluble glass or ceramic composition can no longer be guaranteed.

Moreover, the invention relates to a process for protection of glassware in a dishwashing machine against corrosion by fixing the device according to the invention to predetermined position within the dishwashing machine, preferably on the racks, most preferably on the upper rack.

In the context of the present invention it is understood by thermal shock the variation of temperature over time suffered by the glass composition when the temperature conditions within the dishwasher vary rapidly, i.e. upon entry of new cold fresh water into the dishwasher between the different cycles.

It is within the scope of the present invention to provide a device comprising a container and a glass composition whereby the thermal shock of the glass composition is reduced. The reduction of the thermal shock provided by the container is measured with the help of the Thermal Shock Reduction Factor method described below. The devices of the present invention comprise a container having a Thermal Shock Reduction Factor (TSRF) of less than 0,9 as defined in the thermal shock test described-below.

Evaluation of the Thermal Shock Reduction Factor (TSRF)

Equipment:

2 Miele G540 “spezial” dishwashing machines

2 glass blocks of 35 g

A temperature probe

Procedure:

The cutlery baskets of the two dishwashers are removed.

One of the glass blocks is placed in the container, for which TSRF is to be evaluated. The glass block enclosed within the container is then placed in an empty compartment of the cutlery basket while the second block is placed directly (without container) in an identical and vicinal compartment of the same cutlery basket.

Both dishwashers are started. One of the dishwashers is run at a normal washing cycle reaching a temperature of 60° C., which is maintained during approximately 10 minutes; the other dishwasher is run at a cold prewash cycle where cold water at 25° C. is circulated.

The cutlery basket containing the two glass blocks is placed at its normal position within the dishwasher in which the wash cycle at 60° C. is running and it is left there for 5 minutes to allow its temperature to reach the equilibrium.

At the end of the 5 minutes period the cutlery basket is removed from the first dishwasher and quickly placed at its normal position within the dishwasher in which the prewash cycle at 25° C. is running.

After 45 seconds the cutlery basket is removed and the temperatures of the two blocks are measured. The thermal shock reduction factor (TSRF) is calculated with the formula:

$$TSRF = \frac{60 - {T}_{1}}{60 - {T}_{2}}$$

Where T₁ is the temperature of the block enclosed in the container to be evaluated and T₂ is the temperature of the free-standing glass block.

The above-identified objects are achieved in a surprisingly simple way by means of the device of the present invention and using the process making use of such device.

In particular holding the shaped bodies of water-soluble glass or ceramic compositions in the container of the device of the present invention reduces the thermal shock suffered by the glass compositions.

Additionally holding the shaped bodies of water-soluble glass or ceramic compositions in the container of the device of the present invention reduces the thermal shock suffered by the glass compositions and minimises the risks of damaging the machine or injuring consumers as any direct contact with the glass or ceramic shaped body is avoided. Thus, development of any sharp edges on dissolution of the shaped body will have no negative impact. Moreover, holding the shaped body in a separate container will avoid the above-identified problems when placing the shaped body, for example, e.g. in the cutlery basket of a dishwashing machine.

In the preferred embodiment of the invention, access to the contents of the container of the inventive device is not possible without destroying the container. This is another measure of minimizing the risk of injuring consumers by any direct contact with glass or ceramic remainders within the container. Therefore a preferred embodiment of the device is disposable and not refillable.

According to one of the preferred embodiments, the inventive device provides for an “end of life” indication for the consumer telling him when there is a need to replace the device to guarantee the best glass protection, as the speed of dissolution of a glass or ceramic shaped bodies is not constant over the whole time due to the fact that the exposed surface of the shaped body is reduced as it dissolves. Therefore, as the shaped body dissolves, it may reach a size, when its exposed surface will not be large enough to guarantee the rate of dissolution, which is sufficient to give full glass protecting benefits. It would be desirable at this stage to replace the device with a new one. By placing a mark in the container as described in the preferred embodiment of the invention the appropriate point in time for such replacement is easily detectable by the consumer.

Also according to a preferred embodiment spacing means are within the container, preferably on the inner face of the plate and/or the cover of the container, in order to avoid the direct contact between the shaped body and the container walls assuring a more efficient water flow around the shaped body which results in a better dissolution of the shaped body and, at the same time, avoids that partially dissolved glass composition from the surface of the glass block which becomes quite sticky could cause the block to adhere to the walls of the container which would result in an insufficient dissolution of the glass.

The spacing means used in the devices of the invention are in the form of protrusions from the walls of the container having a small surface of contact with the glass block in comparison with the total surface of the glass. Preferably the surface of contact between the spacing means and the glass block does not represent more than 20% , preferably not more than 10%, most preferably not more than 5% of the total surface of the glass block.

Finally, when fixing the device of the present invention on the racks, and in particular on the upper rack, the thermal shock described herein-above, is significantly reduced, as the shaped body is held in a place and in surroundings where it is most protected within the dishwashing machine from such thermal shock.

One alternative feature of the invention is the provision of the shaped body and the container as separate items, in the form of a kit, to be assembled by the user. The container can be provided with a snap-fitting lid.

One preferred embodiment of the inventive device will now be described in more detail. In the drawings:

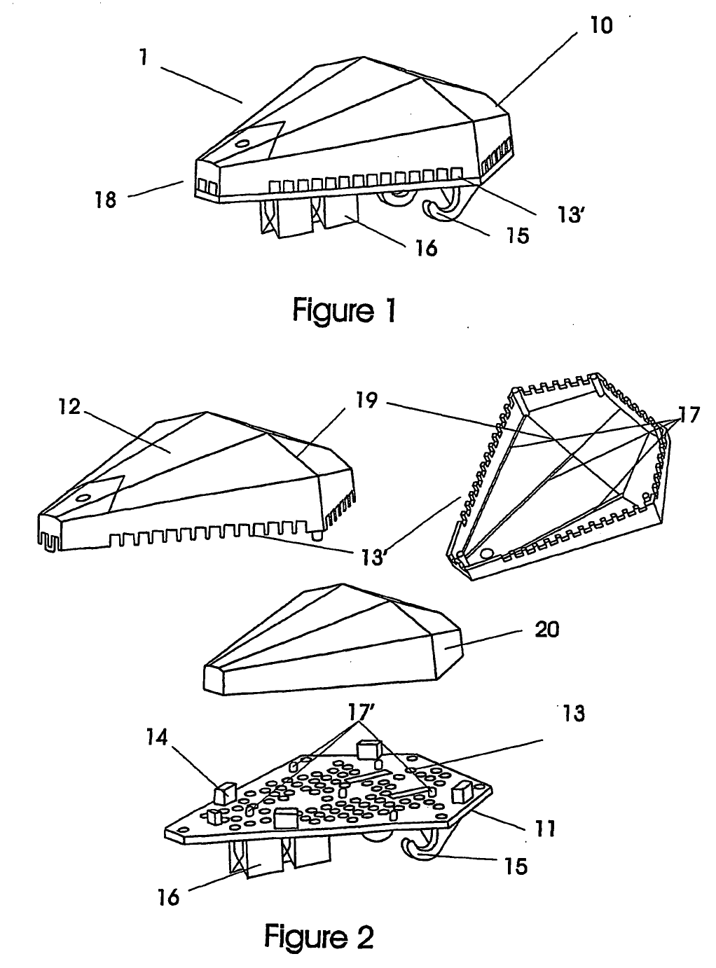

FIG. 1 shows a perspective view of one preferred embodiment of the device of the present invention; and

FIG. 2 shows an exploded view of the embodiment of FIG. 1.

Now referring to FIG. 1, a device 1 according to the present invention comprises a container 10 for holding the shaped body made of water-soluble glass or ceramic composition (not shown in this drawing) as well as means 15, 16 provided on the container 10 to fix it to a pre-determined position within the dishwashing machine. In this preferred embodiment, the fixing means consist of hooks 15 and clips 16 to enable the fixation of the device 1, preferably at vertical or horizontal parts of the racks. Vertical fixation on the upper rack is most preferred for this embodiment of device 1.

More details can be seen from FIG. 2, which is an exploded view. Both the base plate 11 and the cover 12 of the container 10 provides for a number of perforations (holes) 13 and 13′ allowing a controlled circulation of the washing liquor into and out of the container. The control of the circulation is by means of the number and size of the holes 13 and 13′ and by the spacing means 17 and 17′ in the cover 12 and in the base plate 11 of the container. Moreover, on the upper side of the base plate 11 means 14 for fixation of the cover 12 of the container 10 are provided for. It is to be noted that the device is made of two parts, namely the base plate 11 and the cover 12, to enable the introduction of the shaped body 20 during the manufacturing process. It is, however, preferred that the container cannot be easily, at least not without irreversible destruction thereof, disassembled by the consumer to prevent injury by sharp edges of the partially dissolved glass or ceramic shaped body 20. At least part of cover 12 of the container can be made transparent for additionally viewing the shaped body 20, and also for aesthetic reasons.

The “diamond”-like configuration of cover 12 of the container simultaneously provides an “end-of-life” indicator for the shaped body 20. To achieve this, at least the portion of cover 12 adjacent to line 19 is made of transparent material. Experiments have shown that, when the device is vertically fixed with end 18 downwards, the upper edge of the partly dissolved glass or ceramic shaped body 20 only reaches line 19 when the shaped body is almost dissolved. Beyond that point in time, full functionality of the water-soluble glass or ceramic composition can no longer be guaranteed which would then be the appropriate time for the consumer to remove the device from the dishwashing machine and replace it by a fresh one.

The Thermal Shock Reduction Factor of the device of FIGS. 1 and 2 was determined according to the method described above and a value of 0,72 was obtained.

The features disclosed in the foregoing description and the claims may, both separately and in any combination thereof, be material for realising the invention in diverse forms thereof.

1. A device for use in a dishwashing machine to dispense a water-soluble glass or ceramic composition into the machine over a plurality of dishwashing cycles comprising:
a) a shaped body (20) made of water-soluble glass or ceramic composition; within
b) a container (10) for holding said shaped body (20) with at least part of its walls (10) having perforations (13, 13′) allowing circulation of the washing liquor into and out of the container, characterized in that the container (10) has a Thermal Shock Reduction Factor (TSRF) of less than 0,9 as measured by the following formula:
$$TSRF = \frac{60 - {T}_{1}}{60 - {T}_{2}}$$
wherein:
T₁ is the temperature of a first shaped body (20) disposed within a container (10) taken after the container (10) is acclimatized to a temperature of 60° C. in an automatic dishwasher and then placed in another automatic dishwasher, running at 25° C., for 45 seconds; and
T₂ is the temperature of a second unprotected shaped body (20) taken after exposure to the same conditions as the first shaped body (20).

2. A device according to claim 1 wherein the container (10) has a Thermal Shock Reduction Factor of less than 0,8, most preferably less than 0,70.

3. A device according to anyone of claims 1 or 2, wherein the container comprises spacing means (17, 17′) to avoid direct contact of the shaped body (20) and the walls of the container (10, 11′).

4. A device according to claim 3 wherein the surface of contact between the spacing means and the glass block does not represent more than 20%, preferably not more than 10%, most preferably not more than 5% of the total surface of the glass block.

5. A device according to any preceding claim, wherein means (15, 16) are provided on the container (10) or connected therewith to fix the container to a pre-determined position within the dishwashing machine.

6. A device according to claim 5, wherein said means (15, 16) are adapted to fix the container to a pre-determined position on the racks of the dishwashing machine.

7. A device according to anyone of claims 1 to 6, wherein at least a part (18) of the container is made at least partially of transparent material.

8. A device according to anyone of claims 1 to 7, wherein the container (10) is provided for in a form, which does not allow access to the contents thereof without irreversible destruction of the container.

9. A device according to anyone of claims 1 to 8, wherein the container comprises means (19) for detection of that point in time beyond which full functionality of the water-soluble glass or ceramic composition can no longer be guaranteed.

10. Process for protection of glassware in a dishwashing machine against corrosion by fixing a device according to any one of claims 1 to 9 to a predetermined position within the dishwashing machine.

11. Process according to claim 10, wherein the device is fixed to a predetermined position on the racks of the dishwashing machine.

12. Process according to claim 11, wherein the device is fixed to a predetermined position on the upper rack of the dishwashing machine
